(19) United States
(12) Patent Application Publication
(10) Pub. No.: US 2007/0266361 A1
(43) Pub. Date: Nov. 15, 2007

(54) LOGIC VERIFICATION METHOD, LOGIC VERIFICATION APPARATUS AND RECORDING MEDIUM

(75) Inventor: KAZUHIRO YAMAMOTO, TOKYO (JP)

Correspondence Address: J C PATENTS, INC., 4 VENTURE, SUITE 250, IRVINE, CA, 92618, US

(73) Assignee: ADVANTEST CORPORATION, TOKYO (JP)

(21) Appl. No.: 11/681,056

(22) Filed: Mar. 1, 2007

Related U.S. Application Data
(63) Continuation of application No. PCT/JP05/15806, filed on Aug. 30, 2005.

(30) Foreign Application Priority Data
Sep. 1, 2004 (JP) 2004-254872

(51) Int. Cl. G06F 17/50

(52) U.S. Cl. 716/17

(57) ABSTRACT

There is provided a logic verification method for performing logic verification of an integrated circuit by using device data defining functions of the integrated circuit. The logic verification method includes reading device data made up by a plurality of pieces of logic module data each including (i) first circuit data defining a predetermined function by using a hardware description language and (ii) second circuit data defining the same predetermined function by using a logic circuit including a gate circuit, wherein the second circuit data includes timing information for an operation performed over time, selecting one of the first circuit data and second circuit data for each of the plurality of pieces of logic module data making up the device data, and executing logic verification based on device data made up by selected pieces of circuit data.

### CROSS REFERENCE TO RELATED APPLICATION

This is a continuation application of PCT/JP2005/015806 filed on Aug. 30, 2005 which claims priority from a Japanese Patent Application(s)

No. 2004-254872 filed on Sep. 1, 2004,

the contents of which are incorporated herein by reference.

### BACKGROUND

1. Technical Field

The present invention relates to a logic verification method and a logic verification apparatus for executing logic verification of device data and a recording medium storing thereon a program causing a computer to function as a logic verification apparatus.

2. Related Art

In recent years, the developing process of integrated circuits such as super LSIs generally utilizes computer assisted design (CAD). According to such a developing process based on CAD, abstract circuit data, which corresponds to functions of an integrated circuit to be developed, is defined by using a so-called hardware description language, and the defined circuit data is used to form a concrete circuit structure to be mounted on a chip.

For example, the entire integrated circuit is divided into a plurality of functional blocks, and circuit data is generated which describes each of the functional blocks by using a register transfer level (RTL). Based on the RTL-described circuit data, a logic circuit is generated by using a logic synthesis tool or the like, and the layout of the logic circuits on the integrated circuit and the like are determined. In this manner, the concrete structure of the integrated circuit is determined (refer to Unexamined Japanese Patent Application Publication No. H10-283388, for example).

In reality, however, the above-described process alone does not complete the design and verification of every type of integrated circuits. To be specific, the characteristics of some integrated circuits make it difficult to realize sufficient performance for the integrated circuits by designing the integrated circuits only based on the RTL-described circuits.

For example, in the case of a timing generating circuit that is required to control a time delay in the order of several picoseconds, it is difficult to generate an RTL-described circuit including therein such a time delay. This problem is shared by a logic circuit and the like which are generated based on the RTL-described circuit. For this reason, when designing an integrated circuit which attaches importance to predetermined characteristics, for example, a circuit that performs highly minute time delay control, a designer is required to separately and specifically design a logic circuit corresponding to at least part of the integrated circuit, for generation of the logic circuit, by way of a schematic editor, a layout editor, and the like.

The integrated circuits which attach importance to predetermined characteristics such as a time delay have another problem regarding verification in addition to the above-described difficulties in the designing process. Specifically speaking, when designing this type of integrated circuit, the designer separately and specifically designs at least some of the logical circuits which are generated during the designing process. Therefore, not only the RTL-described circuits but also the logic circuits need to be subjected to logic verification.

The logic verification based on the RTL-described circuit, which is device data defining a predetermined function only by using a hardware description language, can be completed within a short time period. However, if the integrated circuit corresponding to the device data needs to perform an operation over time, such as a data holding operation, between the constituents therein, the logic verification may not be sufficient. This is because the device data defining a predetermined function only by using a hardware description language basically has difficulties in sufficiently defining an operation to be performed over time. Therefore, the result of the logic verification based on such device data can not reliably judge whether the operation to be performed over time has a problem. For the reasons stated above, a conventional designing method of an integrated circuit, especially a designing method of a high-speed operating integrated circuit such as a timing generating circuit, requires the following process to be performed after logic verification of device data defining functions only by using a hardware description language. In correspondence with a function of the integrated circuit regarding an operation to be performed over time, in particular, the designer generates a logic circuit part of which is manually designed by adding timing information with the use of a schematic editor and the like, and logic verification of another device data formed by using this logic circuit needs to be executed.

The logic verification of the device data made up only by the logic circuits each including timing information can verify the function of the integrated circuit regarding an operation to be performed over time. However, this logic verification poses a problem of a long time period. Therefore, the above-described integrated circuit designing method can realize an integrated circuit demonstrating high reliability for high-speed operation, but requires a long time period and increases the turn around time (TAT).

### SUMMARY

In view of the above-described problems, an advantage of some embodiments of the present invention is to realize a logic verification method, a logic verification apparatus and a recording medium, which enable logic verification to be completed within a short time period in the designing process of an integrated circuit that attaches importance to timing information.

To solve the above-mentioned problems, a first embodiment of the present invention provides a logic verification method for executing logic verification of an integrated circuit by using device data defining functions of the integrated circuit. The logic verification method includes reading device data made up by a plurality of pieces of logic module data each including reading device data made up by a plurality of pieces of logic module data each including first circuit data defining a predetermined function and second circuit data defining the same predetermined function in more detail than the first circuit data, selecting one of the first circuit data and second circuit data for each of the plurality of pieces of logic module data making up the device data, and executing the logic verification based on device data made up by selected pieces of circuit data.

The device data read in the reading may be made up by the plurality of pieces of logic module data each including (i) the first circuit data defining the predetermined function by using a hardware description language and (ii) the second circuit data defining the same predetermined function by using a logic circuit including a gate circuit, and the second circuit data includes timing information for an operation performed over time.

The first circuit data may define the predetermined function by using a register transfer level.

The second circuit data may include, as the timing information, information regarding a time delay.

In the selecting, circuit data may be selected based on input selection information.

The logic verification method may further include translating, into a machine language, the device data except for pieces of circuit data which are not selected in the selecting, between the selecting and logic verification execution. Here, the logic verification may be executed based on the device data which has been translated in the translating.

A second embodiment of the present invention provides a logic verification apparatus for executing logic verification of predetermined device data. The logic verification apparatus includes a test bench that stores thereon a test pattern to be used for the verification, a device data storing section that stores thereon device data made up by a plurality of pieces of logic module data each including first circuit data defining a predetermined function and second circuit data defining the same predetermined function in more detail than the first circuit data, and a verification executing section that executes the logic verification of the device data by using the test pattern, based on selected one of the first circuit data and second circuit data.

The device data storing section may store thereon the device data made up by the plurality of pieces of logic module data each including (i) the first circuit data defining the predetermined function by using a hardware description language and (ii) the second circuit data defining the same predetermined function by using a logic circuit including a gate circuit, and the second circuit data includes timing information for an operation performed over time.

The test pattern may include therein selection information indicating which one of the first circuit data and second circuit data is to be selected for each of the plurality of pieces of logic module data, and the verification executing section may execute the logic verification after selecting one of the first circuit data and second circuit data for each of the plurality of pieces of logic module data based on the selection information.

A third embodiment of the present invention provides a recording medium storing thereon a program causing a computer to execute logic verification of an integrated circuit. The program includes a first circuit data code that causes the computer to emulate a predetermined function of the integrated circuit, a second circuit data code that causes the computer to emulate the predetermined function of the integrated circuit in more detail than the first circuit data code, a selector circuit data code that causes the computer to emulate a selecting function of selecting one of (i) data obtained by the first circuit data code which causes the computer to emulate the function and (ii) data obtained by the second circuit data code which causes the computer to emulate the function, and a verification execution code that causes the computer to execute the logic verification of the integrated circuit based on the emulated predetermined function of the integrated circuit and the emulated selecting function.

The first circuit data code may cause the computer to emulate the predetermined function which is defined by using a hardware description language, and the second circuit data code may cause the computer to emulate the predetermined function which is defined by using a logic circuit including a gate circuit and timing information for an operation performed over time.

The first circuit data code may cause the computer to emulate the predetermined function which is defined by using a register transfer level.

The second circuit data code may cause the computer to emulate the predetermined function which is defined by using the logic circuit including, as the timing information, information regarding a time delay.

The selector circuit data code may cause the computer to emulate the selecting function of selecting, based on input selection information, one of (i) the data obtained by the first circuit data code which causes the computer to emulate the function and (ii) the data obtained by the second circuit data code which causes the computer to emulate the function.

A fourth embodiment of the present invention provides a recording medium storing thereon a program causing a computer to execute logic verification of an integrated circuit. The program includes a plurality of logic module data codes that cause the computer to emulate functions of a plurality of parts of the integrated circuit, and a verification execution code that causes the computer to execute the logic verification of the integrated circuit. Here, each of the plurality of logic module data codes includes a first circuit data code that causes the computer to emulate a function of a corresponding one of the parts of the integrated circuit, a second circuit data code that causes the computer to emulate the function of the corresponding part of the integrated circuit in more detail than the first circuit data code, and a selector circuit data code that causes the computer to emulate a selecting function of selecting one of (i) data obtained by the first circuit data code which causes the computer to emulate the function and (ii) data obtained by the second circuit data code which causes the computer to emulate the function, and the verification execution code causes the computer to execute the logic verification of the integrated circuit based on the emulated functions of the plurality of parts of the integrated circuit and the emulated selecting function.

The first circuit data code may cause the computer to emulate the predetermined function which is defined by using a hardware description language, and the second circuit data code may cause the computer to emulate the predetermined function which is defined by using a logic circuit including a gate circuit and timing information for an operation performed over time.

Each of the plurality of logic module data codes may be defined in such a manner that the data which is not selected by the selector circuit data code is not translated into a machine language, which is used by a logic verification apparatus.

A fifth embodiment of the present invention provides a recording medium storing thereon a program causing a computer to execute logic verification of an integrated circuit. The program includes one or more first circuit data codes that cause the computer to emulate one or more functions of one or more parts of the integrated circuit, one or more second circuit data codes that cause the computer to emulate, in more detail than the first circuit data codes, one or more functions of different one or more parts of the integrated circuit, a connection data code that causes the computer to emulate a method of data transmission between the parts of the integrated circuit the functions of which are emulated by the computer based on the first and second circuit data codes, and a verification execution code that causes the computer to execute the logic verification of the integrated circuit based on the emulated functions of the parts of the integrated circuit and the emulated method of data transmission.

The first circuit data codes may cause the computer to emulate the functions which are each defined by using a hardware description language, and the second circuit data codes may cause the computer to emulate the functions which are each defined by using a logic circuit including a gate circuit and timing information for an operation performed over time.

The first circuit data codes may cause the computer to emulate the functions which are each defined by using a register transfer level, and the second circuit data codes may cause the computer to emulate the functions which are each defined by using the logic circuit including, as the timing information, information regarding a time delay.

Here, all the necessary features of the present invention are not listed in the summary. The sub-combinations of the features may become the invention.

### BRIEF DESCRIPTION OF THE DRAWINGS

FIG. 1 is a block diagram illustrating the configuration of a logic verification apparatus relating to a first embodiment.

FIG. 2 is a conceptual view schematically illustrating the data structure of device data stored on a device data storing section provided in the logic verification apparatus.

FIG. 3 is a flow chart illustrating the operation of a verification executing section provided in the logic verification apparatus.

FIG. 4 is a block diagram illustrating the configuration of a logic verification apparatus relating to a second embodiment.

FIG. 5 is a conceptual view schematically illustrating the data structure of device data stored on a device data storing section provided in the logic verification apparatus.

FIG. 6 is a flow chart illustrating the operation of a verification executing section provided in the logic verification apparatus.

FIG. 7 is a conceptual view schematically illustrating one example of the data structure of the device data when the selection to be made by selector circuit data is defined.

FIG. 8 is a conceptual view schematically illustrating another example of the data structure of the deice data when the selection to be made by the selector circuit data is defined.

FIG. 9 is a schematic diagram illustrating one example of a logic verification operation performed by using first circuit data and second circuit data which are generated based on device data.

FIG. 10 is a block diagram illustrating the configuration of a logic verification apparatus relating to a third embodiment.

FIG. 11 is a conceptual view schematically illustrating the data structure of a test pattern stored on a test bench provided in the logic verification apparatus.

### DESCRIPTION OF EXEMPLARY EMBODIMENTS

The following described the best mode for carrying out a logic verification method, a logic verification apparatus and a recording medium relating to the present invention (hereinafter simply referred to as embodiments). It is apparent that the embodiments described in the following do not limit the present invention thereto.

### First Embodiment

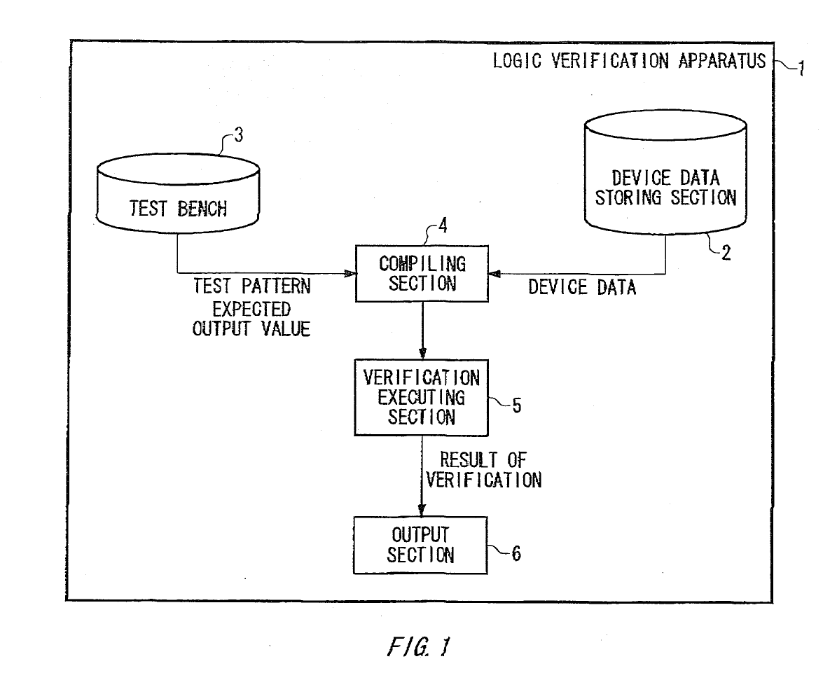

To start with, a logic verification apparatus relating to a first embodiment of the present invention is described. FIG. 1 is a schematic view illustrating a logic verification apparatus 1 relating to the first embodiment. The logic verification apparatus 1 includes therein a device data storing section 2 for storing thereon device data and the like, a test bench 3 for storing thereon test patterns to be used for performing logic verification and expected output values each of which is a value expected to be output as a result from the device data, a compiling section 4 for translating the above-mentioned data into a machine language, a verification executing section 5 for executing logic verification with the use of the data obtained by translating the data into a machine language, and an output section 6 for outputting the result of the verification obtained by the verification executing section 5.

The device data storing section 2 stores thereon device data describing the functions of a corresponding integrated circuit. To be more specific, the device data storing section 2 has a function of storing thereon first device data made up only by first circuit data (described later) such as RTL-described circuit data and second device data 7 (described later) which is shown as one example of device data relating to the claims of the present application. In the first embodiment, the logic verification apparatus 1 performs verification of the first device data, and uses the response result of the verification to perform logic verification of the second device data 7. For this reason, the device data storing section 2 also stores thereon the response result obtained by the verification of the first device data. The structure of the device data will be described later in detail, and thus not mentioned here.

The test bench 3 stores thereon the test patterns to be used for performing logic verification and expected output values, and outputs the test patterns and expected output values to the verification executing section 5 as requested. The test pattern is used as input data when a simulated operation is performed based on the device data stored on the device data storing section 2, and made up by data corresponding to the operations of the corresponding integrated circuit. The expected output value is data indicating an expected value of a response result which is expected to be produced by the corresponding integrated circuit when the test pattern is input into the integrated circuit.

The compiling section 4 translates the data stored on the device data storing section 2 and the test patterns and the like stored on the test bench 3 into a machine language. Since the verification executing section 5 is typically configured by an electronic computer and the like, the data to be input into the verification executing section 5 needs to be converted into data in a format which can be processed by the electronic computer and the like. For this reason, the compiling section 4 is provided as the preceding stage of the verification executing section 5 in the first embodiment. Here, since the contents of the data are not changed by the translation performed by the compiling section 4, the device data and other data are referred to by the same names herein before and after the translation.

The verification executing section 5 verifies the device data. The verification executing section 5 has a function of judging whether the simulated operation based on the device data is equivalent to an operation to be performed by the corresponding integrated circuit, based on the data stored on the device data storing section 2 and test bench 3.

As described above, the logic verification apparatus 1 relating to the first embodiment has a function of performing logic verification based on a plurality of pieces of device data stored on the device data storing section 2. In detail, the logic verification apparatus 1 first applies a test pattern to the first device data to obtain a response result, and compares the response result with an expected output value to confirm that the test pattern, expected value, and first device data do not include therein bugs. After the confirmation is made, the logic verification apparatus 1 applies a test pattern to the second device data 7 (which is described in detail later) to obtain a response result, compares the obtained response result with the response result obtained in association with the first device data, and outputs the result of the comparison via the output section 6.

The following describes the device data stored on the device data storing section 2. The device data represents the corresponding integrated circuit in simulation. To be specific, the device data is made up by a plurality of pieces of logic module data respectively corresponding to the functions of the integrated circuit, and connection data indicating the manner of connecting the pieces of logic module data. Based on these pieces of data, the device data represents in simulation the integrated circuit.

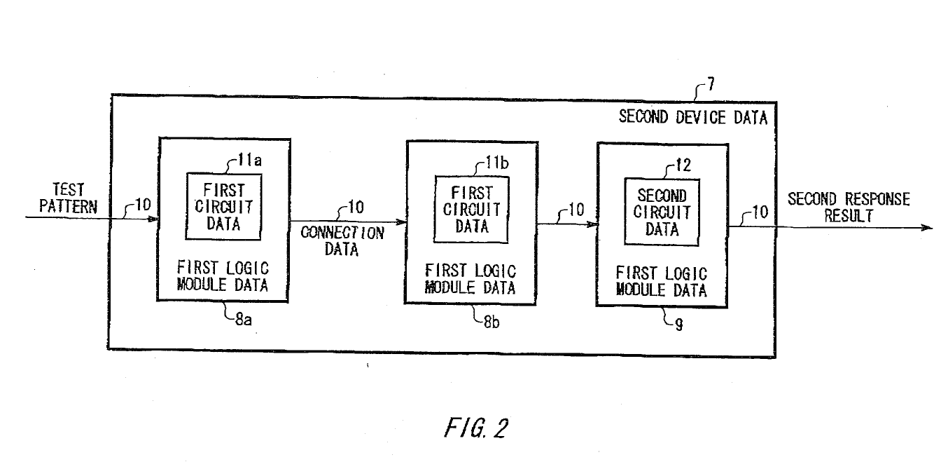

FIG. 2 is a conceptual view used to illustrate the structure of the second device data 7 which is shown as one example of the device data relating to the claims of the present application. Here, the second device data 7 is part of the device data stored on the device data storing section 2. As shown in FIG. 2, the second device data 7 is made up by pieces of first logic module data 8a and 8b, and second logic module data 9 which respectively describe different functions of the corresponding integrated circuit, and connection data 10 describing the data transmission manner between the pieces of logic module data. Here, the conceptual view shown in FIG. 2 only illustrates one example of the structure of the device data. It is apparent that the numbers of the pieces of first logic module data 8 and of the pieces of second logic module data 9 and the specific data transmission manner described by the connection data 10 are varied depending on the structure of the corresponding integrated circuit.

The pieces of first logic module data 8a and 8b respectively include therein pieces of first circuit data 11a and 11b. The pieces of first circuit data 11a and 11b respectively define the functions of the pieces of first logic module data 8a and 8b by using a hardware description language. To be specific, the pieces of first circuit data 11a and 11b define the predetermined functions by using a register transfer level (RTL), for example. The pieces of first circuit data 11a and 11b are configured so as to output data corresponding to the functions, in response to the data input when the logic verification is executed by the verification executing section 5.

The second logic module data 9 includes therein second circuit data 12. The second circuit data 12 defines a predetermined function including timing information. Specifically speaking, the second circuit data 12 is formed by logic circuits including a gate circuit such as a logical AND circuit. Note that the timing information is information required by a circuit for performing an operation over time, for example, a data holding operation, between the constituents within the integrated circuit. For example, the timing information indicates a time delay, a setup time, a holding time, and the like.

The connection data 10 defines the data transmission manner between the pieces of first logic module data 8a and 8b and second logic module data 9. According to the definition of the connection data 10 relating to the first embodiment shown in FIG. 2, the test pattern input into the second device data 7 is processed in a predetermined manner by the first logic module data 8a, first logic module data 8b, and second logic module data 9 in the stated order. As a result of the processes, a response result is generated.

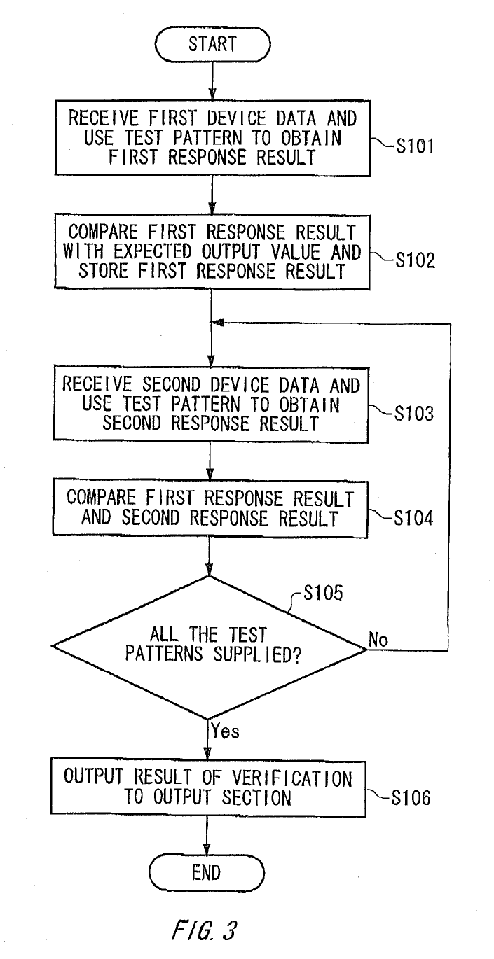

The following describes the operation performed by the logic verification apparatus relating to the first embodiment. FIG. 3 is a flow chart illustrating the operation of the logic verification apparatus relating to the first embodiment, more specifically, the operation of the verification executing section 5. The verification executing section 5 receives the first device data which has been translated into a machine language via the compiling section 4, and applies the test pattern input by the test bench 2, to obtain a first response result, which is a response result generated in response to the input test pattern (step S101). The verification executing section 5 compares the obtained first response result with the expected output value to confirm that the test pattern and the like do not have an error, and stores the first response result onto the device data storing section 2 after the confirmation is made (step S102).

After this, the verification executing section 5 receives the second device data 7, and applies the test pattern input by the test bench 3 to the second device data 7, to obtain a second response result which is generated by the processes sequentially performed by the pieces of first logic module data 8a and 8b, and second logic module data 9 (step S103). Subsequently, the verification executing section 5 compares the newly obtained second response result with the first response result obtained and stored in the step S102, to verify whether the second device data 7 provides an expected function (step S104).

Following this, the verification executing section 5 judges whether all the test patterns have been applied to the second device data 7 (step S105). When judged positively (step S105:Yes), the verification executing section 5 outputs the result of the verification to the output section 6 (step S106), and completes the verification. When judged negatively (step S105:No), the verification executing section 5 repeats the above-described process starting from the step S103.

The following describes the advantages of the logic verification apparatus relating to the first embodiment. Executing the logic verification by using the second device data 7 made up by the first logic module data 8 and second logic module data 9 which have different data structures from each other, the logic verification apparatus relating to the first embodiment can complete the logic verification within a shorter time period. The advantage is described in the following.

As mentioned earlier, the device data made up only by using logic circuits including timing information makes it possible to verify a portion of the device data corresponding to an operation to be performed over time, but requires a long time period to complete the logic verification. Therefore, in the conventional art, logic verification requiring a long time period is indispensable for designing a highly-reliable integrated circuit.

However, even if the device data includes a portion corresponding to an operation performed over time, it is not necessary to verify every logic circuit when the logic verification of the device data is performed. Specifically speaking, not all of the functions of the corresponding integrated circuit perform an operation with the timing information, such as a setup time, a holding time and a time delay, being minutely controlled. Normally, most of the functions can be satisfactorily defined by using RTL-described circuits, and only some of the functions are configured so as to perform an operation with the timing information being minutely controlled.

Considering the above, the second device data 7 is configured so as to include therein a plurality of pieces of logic module data each of which differently defines a function of a different section of the integrated circuit, according to the logic verification apparatus relating to the first embodiment. In the second device data 7, the second logic module data 9 including therein the second circuit data 12 defining a corresponding function by using a logic circuit such as a gate circuit is used to define a function of the integrated circuit which performs an operation with the timing information being minutely controlled. Meanwhile, the first logic module data 8 including therein the first circuit data 11 which defines a function by using a hardware description language, such as the RTL-described circuit, is used to define a different type of function of the integrated circuit.

By using the device data having the above-described configuration, the logic verification apparatus relating to the first embodiment can perform accurate logic verification within a short time period. In detail, referring to a function of the integrated circuit which needs to include timing information, for example, a function for which corresponding circuit data is manually generated a designer, logic verification performed based on the second circuit data 12 which is formed by using a gate circuit and includes timing information. Therefore, the first embodiment has an advantage of achieving more accurate logic verification, when compared to logic verification performed by using device data which is made up only by pieces of circuit data defined by using a hardware description language.

Referring to a function of the integrated circuit which does not need to perform an operation with the timing information being minutely controlled, logic verification is performed by using the first circuit data 11 which defines the function by using a hardware description language. Therefore, the first embodiment has an advantage of completing logic verification within a shorter time period, when compared to logic verification performed by using device data which is made up only by logic circuits such as a gate circuit,

Another advantage of the logic verification apparatus relating to the first embodiment is that the test patterns and expected output values stored on the test bench 3 can be the same as in the conventional art. Conventionally, when logic verification is performed by using the device data defining the functions only by using a hardware description language, such as the RTL, and the device data defining the functions only by using gate circuits, the test patterns and expected output values utilized are event-based data in both cases. Therefore, the conventional event-based test patterns and expected output values can be used in the first embodiment, where the logic verification is performed by using the second device data 7 made up by both types of device data. Consequently, the logic verification apparatus relating to the first embodiment can be easily realized.

According to the logic verification apparatus relating to the first embodiment, the second device data 7 is made up by both the first logic module data 8 and second logic module data 9. With this configuration, the logic verification can be performed before all the logic circuits corresponding to the entire integrated circuit are generated. This is another advantage of the first embodiment.

In the case of top-down designing process of an integrated circuit, for example, the specifications of the integrated circuit are generally determined at the beginning. After this, the functions are determined in accordance with the specifications, and the determined functions are defined by way of a hardware description language. In accordance with the definitions, logic circuits are generated by using a gate circuit (manually by a designer, if necessary). Therefore, before the generation of the logic circuits starts, data defining the functions by using the hardware description language is already generated.

In view of the above in combination with the idea relating to the first embodiment of the present invention, once the generation of logic circuits corresponding to part of the integrated circuit is completed, for example, the generated logic circuits can be used to form second logic module data including second circuit data therein. Meanwhile, referring to the remaining part of the integrated circuit for which logic circuits have not been generated, the circuit data defining the functions by using a hardware description language is used to form the first logic module data including therein the first circuit data. In this way, the first embodiment has an advantage that the logic verification can be performed once logic circuits corresponding to part of the integrated circuit are generated.

### Second Embodiment

The following describes a logic verification apparatus relating to a second embodiment. According to the logic verification apparatus relating to the second embodiment, each of the pieces of logic module data making up the device data includes both the first circuit data and second circuit data, which are explained in the first embodiment, and one of the first circuit data and second circuit data may be selected for each piece of logic module data when the logic verification is performed. In this way, in the second embodiment, the single piece of device data functions as both the first device data and second device data, which are explained in the first embodiment.

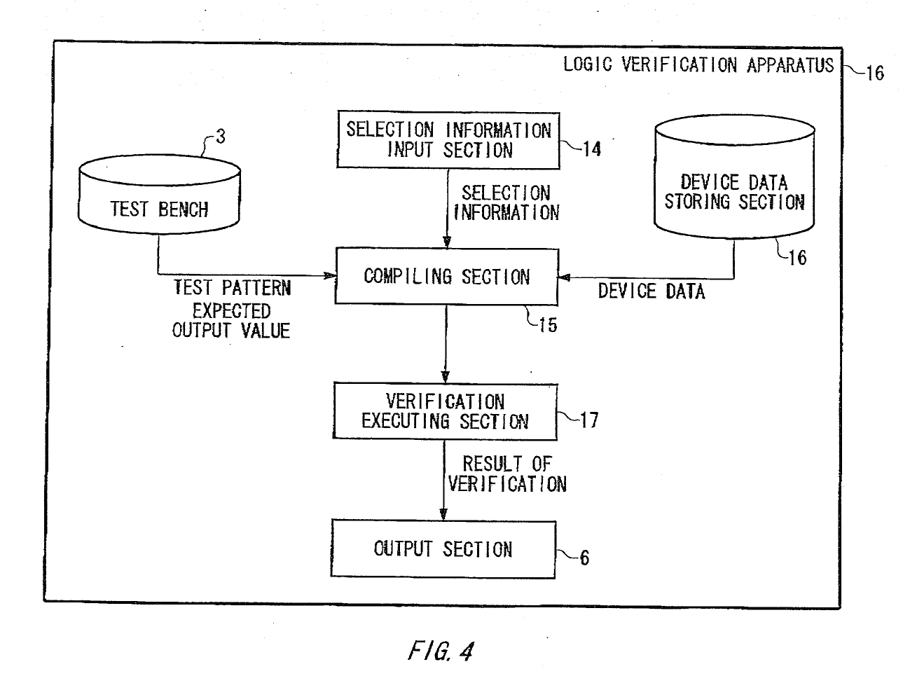

FIG. 4 is a schematic block diagram illustrating the configuration of a logic verification apparatus 13 relating to the second embodiment. In the drawings including FIG. 4, the constituents identified by the same reference numerals as in the first embodiment have the same configurations and functions as the corresponding constituents relating to the first embodiment, unless otherwise stated.

As shown in FIG. 4, the logic verification apparatus 13 relating to the second embodiment includes the same test bench 3 and output section 6 as the logic verification apparatus 1 relating to the first embodiment, Other than these constituents, the logic verification apparatus 13 includes a selection information input section 14 for inputting selection information (described later), a compiling section 15 for translating the data input thereto into a machine language, a device data storing section 16 for storing thereon device data made up by a plurality of pieces of logic module data each of which includes both first circuit data and second circuit data, and a verification executing section 17 for performing logic verification.

The compiling section 15 translates data, for example, a test pattern, input thereto into a machine language, and outputs the translated data to the verification executing section 17. The compiling section 15 may have a function of translating the entire input data. According to the second embodiment, however, the compiling section 15 has a function of translating only necessary data which is selected from the device data input by the device data storing section 16 based on the selection information input via the selection information input section 14. This translating function is described later in detail.

The verification executing section 17 performs verification of second device data which is made up by both first circuit data and second circuit data, similarly to the verification executing section 5 relating to the first embodiment. Specifically speaking, the verification executing section 17 has a function of obtaining a first response result based on first device data that is generated from device data 19, which is described later, and obtaining a second response result based on second device data that is also generated from the device data 19. In addition, the verification executing section 17 has a function of verifying the device data 19 by comparing the first and second response results.

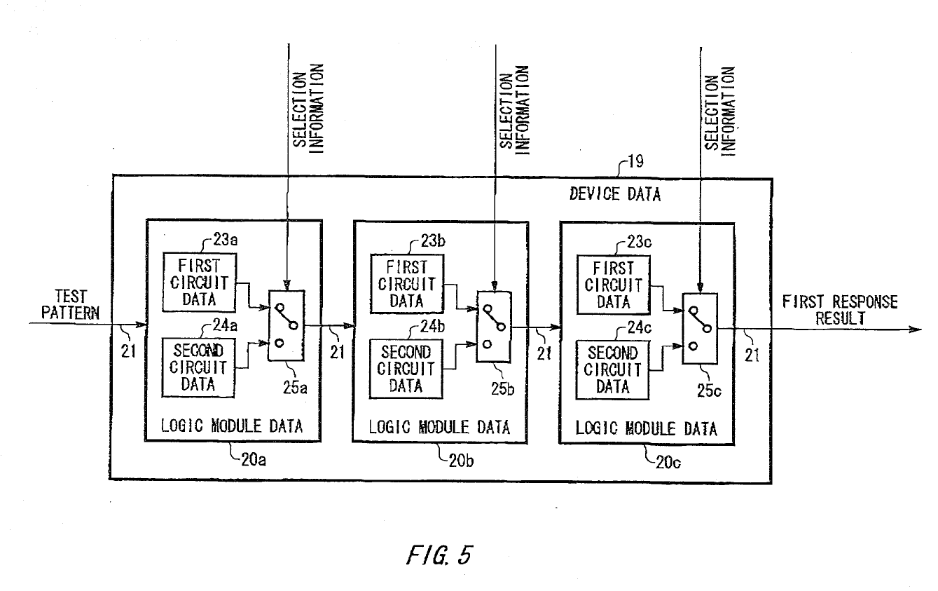

The following describes the data structure of the device data stored on the device data storing section 16. FIG. 5 is a conceptual view illustrating the data structure of the device data 19 stored on the device data storing section 16. As shown in FIG. 5, the device data 19 is made up by a plurality of pieces of logic module data 20a to 20c which respectively define functions of different sections of a corresponding integrated circuit, and connection data 21 which defines the data transmission manner between the pieces of logic module data 20a to 20c.

According to the second embodiment, each of the pieces of logic module data 20a to 20c defines a different function, but has the same data structure. The following describes the data structure of the pieces of logic module data 20a to 20c, by using the logic module data 20a as an example. As shown in FIG. 5, the logic module data 20a is made up by first circuit data 23a that defines a function by using a hardware description language, second circuit data 24a that defines a predetermined function including timing information by using a logic circuit such as a gate circuit, and selector circuit data 25a that defines which one of the first circuit data 23a and second circuit data 24a is to be selected in accordance with the selection information.

The first circuit data 23a and second circuit data 24a define the function assigned to the logic module data 20a. Here, the first circuit data 23a and second circuit data 24a respectively define the same function in different manners from each other. This configuration also applies to the pieces of logic module data 20b and 20c. To be specific, first circuit data 23b and second circuit data 24b define the same function in different manners from each other, and first circuit data 23c and second circuit data 24c define the same function in different manners from each other.

The selector circuit data 25a defines which one of the first circuit data 23a and second circuit data 24a is to be selected. To be specific, the selector circuit data 25a defines information indicating which one of the first circuit data 23a and second circuit data 24a is to be selected when supplied predetermined selection information at the time of the logic verification by the verification executing section 17.

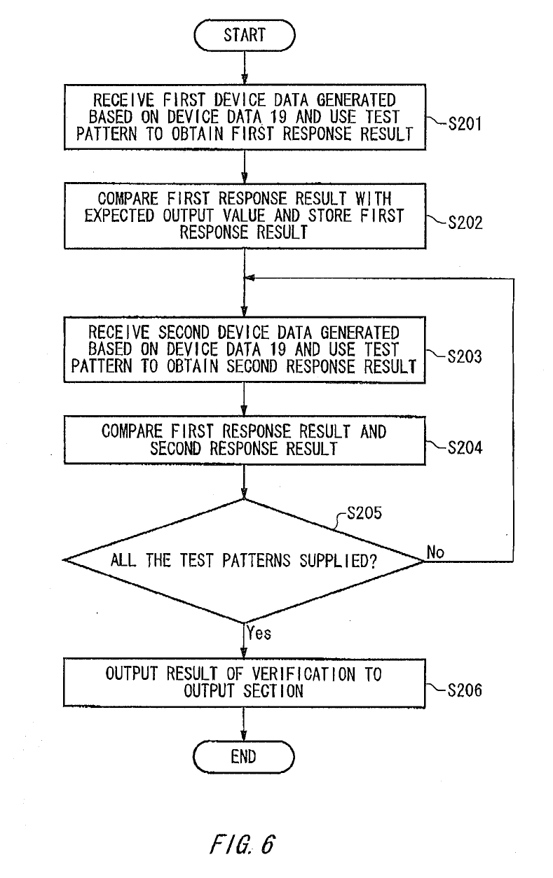

The following describes the operation of the logic verification apparatus 13 relating to the second embodiment. FIG. 6 is a flow chart used to illustrate the operation of the logic verification apparatus 13 relating to the second embodiment. The following description is made with reference to FIG. 6.

To start with, the verification executing section 17 receives the first device data which is generated from the device data 19 and has been translated into a machine language, and uses the test pattern input thereto by the test bench 3 to obtain a first response result in response to the input test pattern (step S201). As in the step S102 relating to the first embodiment, the verification executing section 17 compares the first response result with the expected output value to confirm that the test pattern and the like do not have an error, and stores the first response result onto the device data storing section 16 after the confirmation is made (step S202).

After this, the verification executing section 17 receives the second device data which is generated from the device data 19 and has been translated into a machine language, and applies the test pattern input thereto by the test bench 3 to the second device data, to obtain a second response result in response to the input test pattern (step S203). Subsequently, as in the first embodiment, the verification executing section 17 performs verification based on the comparison between the first and second response results (step S204), judges whether all the test patterns have been supplied (step S205), and outputs the result of the verification (step S206).

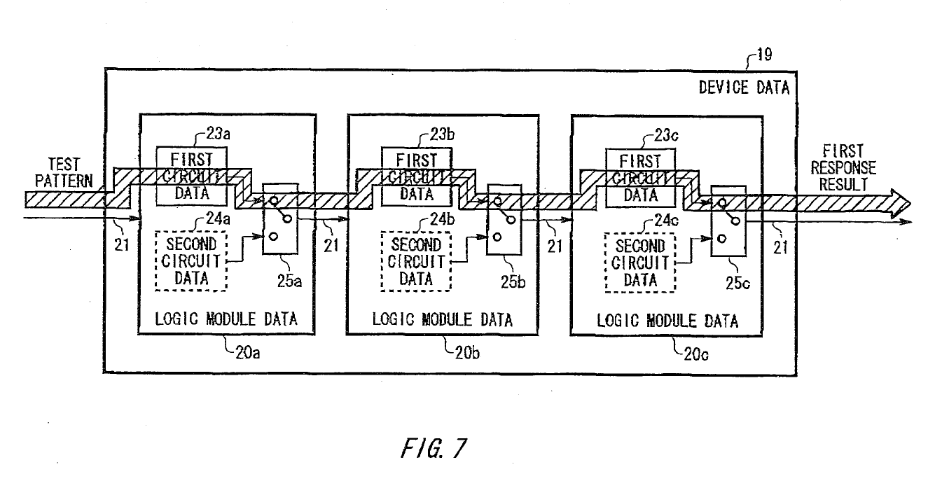

The following describes how the first device data and second device data are generated from the device data 19 in the steps S201 and S203. FIG. 7 is a schematic view used to illustrate the operation performed by the compiling section 15 in the step S201. As mentioned earlier, the compiling section 15 receives the device data 19 by the device data storing section 16, and via the selection information input section 14, the selection information. Here, the selection information indicates the selection to be made by the pieces of selector circuit data 25a to 25c included in the device data 19. Based on the input selection information, the compiling section 15 relating to the second embodiment selects one of the first circuit data and second circuit data for each of the pieces of logic module data 20a to 20c, and only translates the selected circuit data into a machine language.

The above-described operation is specifically explained. In the step S201, since the first device data which is made up only by pieces of first circuit data is required, the selection information input into the compiling section 15 via the selection information input section 14 indicates selection of the pieces of first circuit data 23a to 23c for the pieces of logic module data 20a to 20c. Accordingly, in the step S201, the compiling section 15 selects the pieces of first circuit data 23a to 23c from the logic module data 20a to 20c, and translates, into a machine language, the pieces of first circuit data 23a to 23c and the connection data 21 describing how the pieces of logic module data are connected to each other. In this way, the compiling section 15 outputs the first device data which has been translated into a machine language to the verification executing section 17. Consequently, the compiling section 15 does not output information relating to the pieces of second circuit data 24a to 24c to the verification executing section 17. In the step S202, the test pattern is input into the first device data which is made up only by the pieces of first circuit data as in the first embodiment, and the input test pattern is transmitted as indicated by the arrow in FIG. 7, so that the verification executing section 17 obtains the first response result.

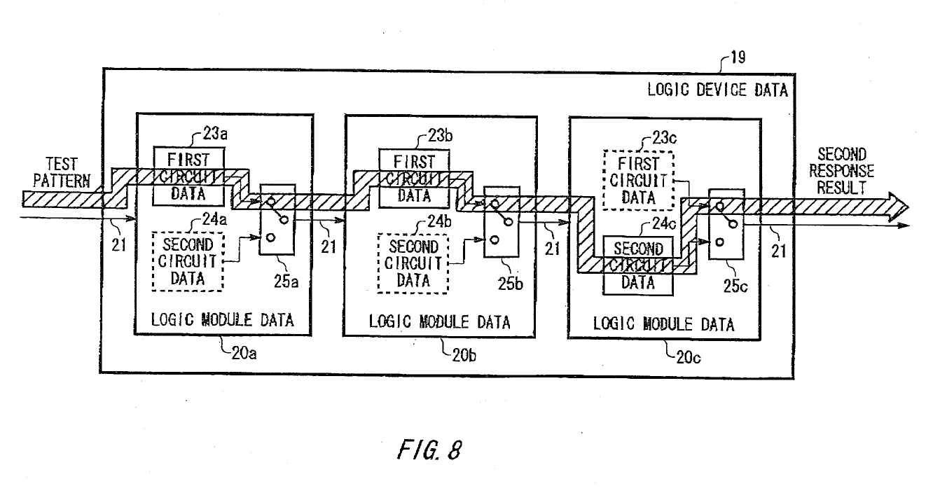

FIG. 8 is a schematic view used to illustrate the operation performed by the compiling section 15 in the step S203. The operation in the step S203 is similarly performed to the operation in the step S201. In detail, the compiling section 15 selects circuit data to translate into a machine language based on the selection information input thereto via the selection information input section 14. To generate the second device data which has the same configuration as the second device data relating to the first embodiment, for example, the pieces of selection information indicating selection of the pieces of first circuit data 23a aid 23b are input into the compiling section 15 in association with the pieces of selector circuit data 25a and 25b, and the selection information indicating selection of the second circuit data 24c is input into the compiling section 15 in association with the selector circuit data 25c. Based on these pieces of selection information, the compiling section 15 translates, into a machine language, the pieces of first circuit data 23a and 23b and the second circuit data 24c (and the connection data 21), out of the pieces of circuit data included in the device data 19. The compiling section 15 outputs the pieces of translated data to the verification executing section 17, as the second device data. In this way, when the verification executing section 17 performs logic verification, the test pattern is transmitted as indicated by the arrow in FIG. 8, so that the verification executing section 17 obtains the second response result.

The following describes the advantages of the logic verification apparatus 13 relating to the second embodiment. Firstly, performing the logic verification by using the second device data which is made up by both the first circuit data and second circuit data, similarly to the logic verification apparatus relating to the first embodiment, the logic verification apparatus 13 relating to the second embodiment can complete the logic verification within a shorter time period, when compared with a logic verification apparatus which performs logic verification by using device data made up only by pieces of second circuit data.

The logic verification apparatus 13 relating to the second embodiment can perform not only the logic verification of the logic circuits including timing information but also the logic verification of device data made up only by pieces of first circuit data defining predetermined functions by using a hardware description language, based on the single piece of device data 19. This advantage is described in the following.

As briefly mentioned in the first embodiment, in reality, if only the logic verification based on the logic circuits including timing information is performed in the designing process of an integrated circuit, the response results for many sections of the integrated circuit are different from the corresponding expected output values. This may make it difficult to identify defective sections. Considering this, in reality, the integrated circuit designing process is normally performed in the following procedure. Device data which is made up only by pieces of data defining functions by using a hardware description language is separately prepared in advance, and such device data is used to perform logic verification. This logic verification is used to confirm that the test patterns, expected output values and the like do not have an error. After the confirmation is made, another logic verification is then performed by using the device data made up by the pieces of the second circuit data.

According to the second embodiment, the logic module data 20 includes therein both the first circuit data 23 defining a function by using a hardware description language and the second circuit data 24 defining the same function as the first circuit data 23 by using a gate circuit including timing information. Therefore, not only the second device data but also the first device data which is made up by pieces of data defined only by a hardware description language can be generated by using the device data 19 made up by the pieces of logic module data 20 described above and the selection information input via the selection information input section 14 in the second embodiment. As a result, it is not necessary to separately prepare the first device data defining functions by using a hardware description language according to the second embodiment.

Since the single piece of device data 19 can be used to realize logic verification of both the first device data and second device data, data management is made easier in the logic verification apparatus 13. When compared to a conventional logic verification apparatus which performs logic verification for the single integrated circuit by using a plurality of pieces of data that are stored on the device data storing section 16, the logic verification apparatus 13 relating to the second embodiment uses half the number of pieces of data. Therefore, the second embodiment can reduce, to approximately half, the probability of an error occurring, for example, during a process of extracting predetermined device data from a plurality of pieces of data stored on the device data storing section 16 in the logic verification apparatu 13. Consequently, the second embodiment has an advantage of being capable of reducing occurrence of problems relating to data management.

According to the second embodiment, the compiling section 15 translates, into a machine language, only the pieces of circuit data essential to the logic verification, out of the pieces of circuit data making up the device data 19. For example, the first device data made up only by the pieces of first circuit data is necessary for the logic verification in the step S201. In other words, the pieces of second circuit data 24a to 24c are not necessary in the step S201. Therefore, the compiling section 15 does not translate the pieces of second circuit data 24a to 24c into a machine language in the step S201.

Since the compiling section 15 is configured in the above-described manner, the logic verification apparatus 13 relating to the second embodiment can further shorten the time period required for the logic verification. To be specific, the device data describing the functions of an integrated circuit is, in reality, made up by a very large number of pieces of logic module data. If the compiling section 15 is required to translate both the first circuit data and second circuit data of each of the very large number of pieces of logic module data, the translation process into a machine language requires an extremely long time period. To remove this drawback, in the second embodiment, only the pieces of circuit data which are actually used for the logic verification (and the connection data) are translated into a machine language out of a large number of pieces of circuit data making up the device data 19. With the above-described configuration, the second embodiment can shorten the time period required for the translation process, thereby shortening the entire time period for logic verification.

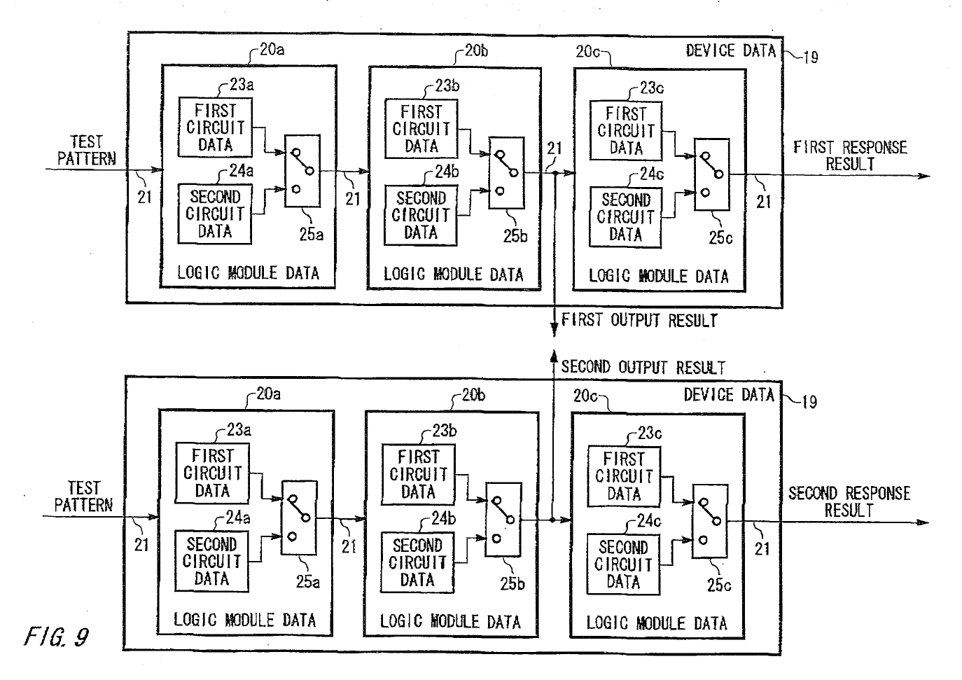

According to the second embodiment, the logic verification apparatus 13 performs the logic verification by comparing the first and second response results to each other which are respectively obtained based on the first device data and second device data as shown in the step S204. However, the second embodiment is not necessarily limited to this configuration. Here, assume a case where the second device data is generated, by selecting the pieces of second circuit data 24b and 24c from the pieces of logic module data 20b and 20c in the device data 19 as shown in FIG. 9 (note that the first device data is assumed to be generated by selecting the pieces of first circuit data 23a to 23c).

In this case, in addition to the comparison between the first and second response results, it is preferable to compare the result output from the first circuit data 23b when the logic verification of the first device data is performed (first output result) and the result output from the second circuit data 24b when the logic verification of the second device data is performed (second output result) as shown in FIG. 9. The reason is described in the following. When the comparison between the first and second response results provides an undesirable result, it is not easy to identify which one of the pieces of second circuit data 24b and 24c has a defect. On the other hand, if the results output from the first circuit data 23b and second circuit data 24b are also compared to each other and the comparison provides an undesirable result, the second circuit data 24b can be easily identified as the defective circuit data.

According to the second embodiment, it is also possible to prepare in advance logic module data 20 in association with a certain function and to generate device data based on the logic module data 20 prepared in advance. Here, the logic module data defining a function which performs an operation with the timing information being minutely controlled is normally generated manually by a designer. This puts a large burden on the designer in the integrated circuit designing process.

In the case of this type of logic module data, however, logic module data which was generated in the past may be used, again depending on the function of the integrated circuit. Therefore, by maintaining a stock of the pieces of logic module data which were generated in the past, the burden on the designer who designs a new integrated circuit can be reduced. This is another advantage of the second embodiment.

### Third Embodiment

The following describes a logic verification apparatus relating to a third embodiment. The logic verification apparatus relating to the third embodiment uses the same type of device data as the logic verification apparatus relating to the second embodiment. In the third embodiment, however, the selection information input section is omitted by varying the data structure of the test patterns stored on the test bench.

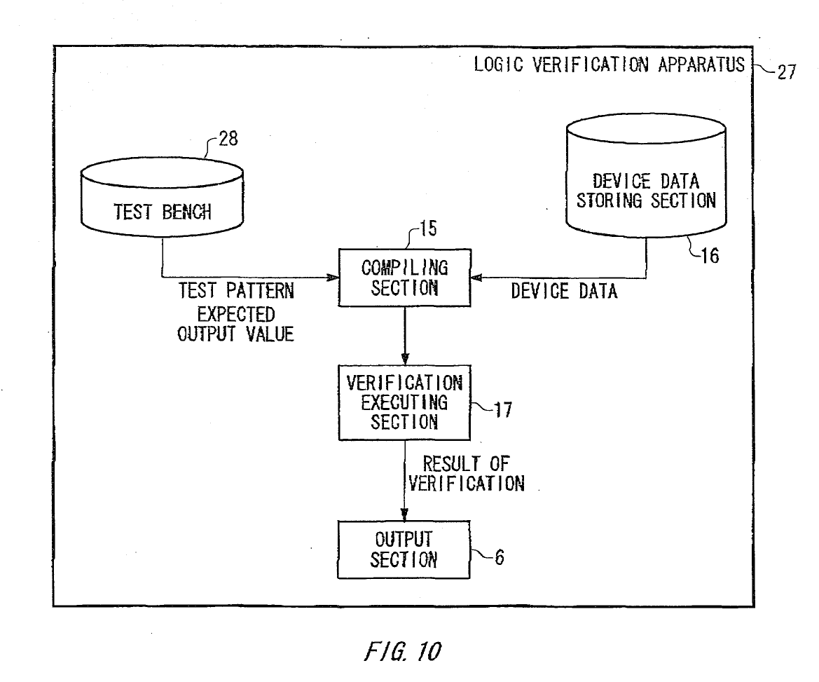

FIG. 10 is a schematic block diagram illustrating the configuration of a logic verification apparatus 27 relating to the third embodiment. In FIG. 10, the constituents identified by the same reference numerals as in the first and second embodiments have the same configurations and functions as the corresponding constituents relating to the first and second embodiments, unless otherwise stated.

As shown in FIG. 10, the logic verification apparatus 27 relating to the third embodiment includes the verification executing section 17, device data storing section 16 and output section 6, similarly to the logic verification apparatus 13 relating to the second embodiment. Also, the logic verification apparatus 27 newly includes therein a test bench 28. To be specific, the device data storing section 16 of the logic verification apparatus 27 relating to the third embodiment stores thereon the same type of device data as in the second embodiment, but the test bench 28 stores thereon test patterns of a different type from the test patterns stored on the test bench 3 relating to the second embodiment. Therefore, the selection information input section is not provided in the logic verification apparatus 27 relating to the third embodiment. Note that the expected output values which are also stored on the test bench 28 are the same as in the first and second embodiments.

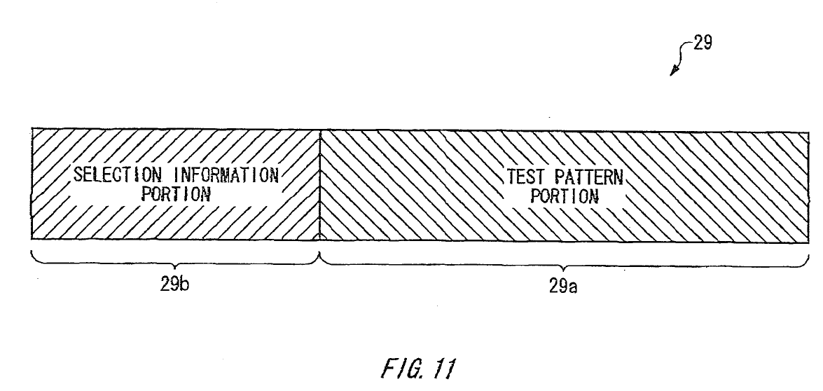

FIG. 11 is a conceptual view schematically illustrating the data structure of a test pattern 29 stored on the test bench 28. As shown in FIG. 11, the test pattern 29 is made up by a test pattern portion 29a which corresponds to the test pattern used in the first and second embodiments and a selection information portion 29b which defines the selection information. Since the test pattern 29 has this structure, the compiling section 15 can identify the selection to be made by the selector circuit data 25 included in the logic module data 20 making up the device data 19, by reading the test pattern 29 stored on the test bench 28 when the logic verification is performed. In this manner, the compiling section 15 is only required to translate the circuit data essential to the logic verification into a machine language,

Configured so as to perform logic verification with the use of the test pattern 29 having the data structure shown in FIG. 11, the logic verification apparatus can be constituted without a selection information input section. Accordingly, the third embodiment has an advantage that the hardware structure of the conventional logic verification apparatus can be used without a change. Also, since the selection information portion 29b is incorporated into the test pattern 29 in advance, the user does not need to configure the selection information when using the logic verification apparatus. Consequently, the third embodiment has an advantage of being capable of performing the verification within a short time period.

The device data and logic module data relating to the above-described embodiments may be programs executable on a computer, or program data to be compiled into programs executable on a computer. In addition, the device data and logic module data may be instructions and data for designating the operating mode and operating method of a different program provided in advance.

Here, it is apparent to the ordinary person skilled in the art to provide a recording medium storing thereon a program causing a computer to perform the operations relating to the above-described embodiments. In this case, the recording medium stores thereon a program causing a computer to execute logic verification of an integrated circuit. The program includes a first circuit data code that causes the computer to emulate a predetermined function of the integrated circuit, a second circuit data code that causes the computer to emulate the predetermined function of the integrated circuit in more detail than the first circuit data code, a selector circuit data code that causes the computer to emulate a selecting function of selecting one of (i) data obtained by the first circuit data code which causes the computer to emulate the function and (ii) data obtained by the second circuit data code which causes the computer to emulate the function, and a verification execution code that causes the computer to execute file logic verification of the integrated circuit based on the emulated predetermined function of the integrated circuit and the emulated selecting function.

A recording medium relating to a different embodiment stores thereon a program causing a computer to execute logic verification of an integrated circuit. The program includes a plurality of logic module data codes that cause the computer to emulate functions of a plurality of parts of the integrated circuit, and a verification execution code that causes the computer to execute the logic verification of the integrated circuit. Here, each of the plurality of logic module data codes includes a first circuit data code that causes the computer to emulate a function of a corresponding one of the parts of the integrated circuit, a second circuit data code that causes the computer to emulate the function of the corresponding part of the integrated circuit in more detail than the first circuit data code, and a selector circuit data code that causes the computer to emulate a selecting function of selecting one of (i) data obtained by the first circuit data code which causes the computer to emulate the function and (ii) data obtained by the second circuit data code which causes the computer to emulate the function, and the verification execution code causes the computer to execute the logic verification of the integrated circuit based on the emulated functions of the plurality of parts of the integrated circuit and the emulated selecting function.

A recording medium relating to a different embodiment stores thereon a program causing a computer to execute logic verification of an integrated circuit. The program includes one or more first circuit data codes that cause the computer to emulate one or more functions of one or more parts of the integrated circuit, one or more second circuit data codes that cause the computer to emulate, in more detail than the first circuit data codes, one or more functions of different one or more parts of the integrated circuit, a connection data code that causes the computer to emulate a method of data transmission between the parts of the integrated circuit the functions of which are emulated by the computer based on the first and second circuit data codes, and a verification execution code that causes the computer to execute the logic verification of the integrated circuit based on the emulated functions of the parts of the integrated circuit and the emulated method of data transmission.

What is claimed is:

1. A logic verification method for executing logic verification of an integrated circuit by using device data defining functions of the integrated circuit, the logic verification method comprising:
reading device data made up by a plurality of pieces of logic module data each including first circuit data defining a predetermined function and second circuit data defining the same predetermined function in more detail than the first circuit data;
selecting one of the first circuit data and second circuit data for each of the plurality of pieces of logic module data making up the device data; and
executing the logic verification based on device data made up by selected pieces of circuit data.

2. The logic verification method as set forth in claim 1, wherein
the device data read in the reading is made up by the plurality of pieces of logic module data each including (i) the first circuit data defining the predetermined function by using a hardware description language and (ii) the second circuit data defining the same predetermined function by using a logic circuit including a gate circuit, and the second circuit data includes timing information for au operation performed over time.

3. The logic verification method as set forth in claim 2, wherein
the first circuit data defines the predetermined function by using a register transfer level.

4. The logic verification method as Set forth in claim 2, wherein
the second circuit data includes, as the timing information, information regarding a time delay.

5. The logic verification method as set forth in claim 2, wherein
in the selecting, circuit data is selected based on input selection information.

6. The logic verification method as set forth in claim 2, further comprising
translating, into a machine language, the device data except for pieces of circuit data which are not selected in the selecting, between the selecting and logic verification execution, wherein
the logic verification is executed based on the device data which has been translated in the translating.

7. A logic verification apparatus for executing logic verification of predetermined device data, comprising:
a test bench that stores thereon a test pattern to be used for the verification;
a device data storing section that stores thereon device data made up by a plurality of pieces of logic module data each including first circuit data defining a predetermined function and second circuit data defining the same predetermined function in more detail than the first circuit data; and
a verification executing section that executes the logic verification of the device data by using the test pattern, based on selected one of the first circuit data and second circuit data.

8. The logic verification apparatus as set forth in claim 7, wherein
the device data storing section stores thereon the device data made up by the plurality of pieces of logic module data each including (i) the first circuit data defining the predetermined function by using a hardware description language and (ii) the second circuit data defining the same predetermined function by using a logic circuit including a gate circuit, and the second circuit data includes timing information for an operation performed over time.

9. The logic verification apparatus as set forth in claim 7, wherein
the test pattern includes therein selection information indicating which one of the first circuit data and second circuit data is to be selected for each of the plurality of pieces of logic module data, and
the verification executing section executes the logic verification after selecting one of the first circuit data and second circuit data for each of the plurality of pieces of logic module data based on the selection information.

10. A recording medium storing thereon a program causing a computer to execute logic verification of a integrated circuit, the program comprising:
a first circuit data code that causes the computer to emulate a predetermined function of the integrated circuit;
a second circuit data code that causes the computer to emulate the predetermined function of the integrated circuit in more detail than the first circuit data code;
a selector circuit data code that causes the computer to emulate a selecting function of selecting one of (i) data obtained by the first circuit data code which causes the computer to emulate the function and (ii) data obtained by the second circuit data code which causes the computer to emulate the function; and
a verification execution code that causes the computer to execute the logic verification of the integrated circuit based on the emulated predetermined function of the integrated circuit and the emulated selecting function.

11. The recording medium as set forth in claim 10, wherein
the first circuit data code causes the computer to emulate the predetermined function which is defined by using a hardware description language, and
the second circuit data code causes the computer to emulate the predetermined function which is defined by using a logic circuit including a gate circuit and timing information for an operation performed over time.

12. The recording medium as set forth in claim 11, wherein
the first circuit data code causes the computer to emulate the predetermined function which is defined by using a register transfer level.

13. The recording medium as set forth in claim 11, wherein
the second circuit data code causes the computer to emulate the predetermined function which is defined by using the logic circuit including, as the timing information, information regarding a time delay.

14. The recording medium as set forth in claim 11, wherein
the selector circuit data code causes the computer to emulate the selecting function of selecting, based on input selection information, one of (i) the data obtained by the first circuit data code which causes the computer to emulate the function and (ii) the data obtained by the second circuit data code which causes the computer to emulate the function.

15. A recording medium storing thereon a program causing a computer to execute logic verification of an integrated circuit, the program comprising:
a plurality of logic module data codes that cause the computer to emulate functions of a plurality of parts of the integrated circuit; and
a verification execution code that causes the computer to execute the logic verification of the integrated circuit, wherein
each of the plurality of logic module data codes includes:
a first circuit data code that causes the computer to emulate a functional of a corresponding one of the parts of the integrated circuit;
a second circuit data code that causes the computer to emulate the function of the corresponding part of the integrated circuit in more detail than the first circuit data code; and
a selector circuit data code that causes the computer to emulate a selecting function of selecting one of (i) data obtained by the first circuit data code which causes the computer to emulate the function and (ii) data obtained by the second circuit data code which causes the computer to emulate the function, and
the verification execution code causes the computer to execute the logic verification of the integrated circuit based on the emulated functions of the plurality of parts of the integrated circuit and the emulated selecting function.

16. The recording medium as set forth in claim 15, wherein
the first circuit data code causes the computer to emulate the predetermined function which is defined by using a hardware description language, and
the second circuit data code causes the computer to emulate the predetermined function which is defined by using a logic circuit including a gate circuit and timing information for an operation performed over time.

17. The recording medium as set forth in claim 16, wherein
the each of the plurality of logic module data codes is defined in such a manner that the data which is not selected by the selector circuit data code is not translated into a machine language, which is used by a logic verification apparatus.

18. A recording medium storing thereon a program causing a computer to execute logic verification of an integrated circuit, the program comprising:
one or more first circuit data codes that cause the computer to emulate one or more functions of one or more parts of the integrated circuit;
one or more second circuit data codes that cause the computer to emulate, in more detail than the first circuit data codes, one or more functions of different one or more parts of the integrated circuit;
a connection data code that causes the computer to emulate a method of data transmission between the parts of the integrated circuit the functions of which are emulated by the computer based on the first and second circuit data codes; and
a verification execution code that causes the computer to execute the logic verification of the integrated circuit based on the emulated functions of the parts of the integrated circuit and the emulated method of data transmission.

19. The recording medium as set forth in claim 18, wherein
the first circuit data codes cause the computer to emulate the functions which are each defined by using a hardware description language, and
the second circuit data codes cause the computer to emulate the functions which are each defined by using a logic circuit including a gate circuit and timing information for an operation performed over time.

20. The recording medium as set forth in claim 19, wherein
the first circuit data codes cause the computer to emulate the functions which are each defined by using a register transfer level, and
the second circuit data codes cause the computer to emulate the functions which are each defined by using the logic circuit including, as the timing information, information regarding a time delay.
